(19) United States
(12) Patent Application Publication
(10) Pub. No.: US 2026/0336439 A1
(43) Pub. Date: Oct. 29, 2026

(54) CHARGING STATION SYSTEM, CHARGING GUN, AND HEATING DEVICE

(71) Applicant: LITE-ON TECHNOLOGY CORPORATION, TAIPEI CITY (TW)

(72) Inventors: GUAN-YI WU, TAIPEI CITY (TW); SHIH-WEI TAI, TAIPEI CITY (TW)

(21) Appl. No.: 19/250,033

(22) Filed: Jun. 25, 2025

(30) Foreign Application Priority Data
Apr. 27, 2025 (CN) 202520814398.6

(51) Int. Cl. B60L 53/16; B60L 53/31; H02J 50/10; H05B 3/22

(52) U.S. Cl. CPC B60L 53/16; B60L 53/31; H05B 3/22; H02J 50/10

(57) ABSTRACT

A charging station system, a charging gun, and a heating device. The charging station system includes a charging station and a charging gun that is connected to the charging station. The charging gun includes a charging gun body and a heating device that is detachably installed on the charging gun body. The heating device includes a fixing device and a heating module that is disposed in the fixing device. The heating module includes a heater and a heating control circuit that is electrically coupled to the heater. The heater is disposed on one side of the fixing device adjacent to a positioning structure of the charging gun body. The heating control circuit is configured to start the heater, so that the heater is configured to heat the positioning structure of the charging gun body.

### CROSS-REFERENCE TO RELATED PATENT APPLICATION

This application claims the benefit of priority to China Patent Application No. 202520814398.6, filed on Apr. 27, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a charging station system, a charging gun, and a heating device, and more particularly to a charging station system, a charging gun, and a heating device applied to an electric vehicle.

### BACKGROUND OF THE DISCLOSURE

In winter (especially in snowy weather), the positioning structure of a charging gun of a conventional charging station applied to an electric vehicle can easily freeze, so that the charging gun is unable to be used normally.

### SUMMARY OF THE DISCLOSURE

In response to the above-referenced technical inadequacy, the present disclosure provides a charging station system, a charging gun, and a heating device that can effectively improve on the issue in a conventional charging station system.

In order to solve the above-mentioned problems, one of the technical aspects adopted by the present disclosure is to provide a charging station system. The charging station system includes a charging station and a charging gun. The charging gun is connected to the charging station through a connecting wire. The charging gun includes a charging gun body and a heating device. The heating device is detachably installed on the charging gun body. The heating module includes a heater and a heating control circuit. The heater is disposed on one side of the fixing device adjacent to a positioning structure of the charging gun body. The heating control circuit is electrically coupled to the heater. The heating control circuit is configured to start the heater, so that the heater is configured to heat the positioning structure of the charging gun body.

In order to solve the above-mentioned problems, another one of the technical aspects adopted by the present disclosure is to provide a charging gun. The charging gun includes a charging gun body and a heating device. The heating device is detachably installed on the charging gun body. The heating device includes a fixing device and a heating module. The heating module is disposed in the fixing device. The heating module includes a heater and a heating control circuit. The heater is disposed on one side of the fixing device adjacent to a positioning structure of the charging gun body. The heating control circuit is electrically coupled to the heater. The heating control circuit is configured to start the heater, so that the heater is configured to heat the positioning structure of the charging gun body.

In order to solve the above-mentioned problems, yet another one of the technical aspects adopted by the present disclosure is to provide a heating device. The heating device includes a fixing device and a heating module. The heating module is disposed in the fixing device. The heating module includes a heater and a heating control circuit. The heating control circuit is electrically coupled to the heater. The heating control circuit is configured to start the heater, so that the heater is configured to generate heat energy.

Therefore, in the charging station system, the charging gun, and the heating device provided by the present disclosure, by virtue of “a heating device detachably installed on the charging gun body,” and “the heating control circuit is configured to start the heater, so that the heater is configured to heat the positioning structure of the charging gun body,” thereby increasing convenience of use.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view showing a structure of a charging station system according to a first embodiment of the present disclosure;

FIG. 2 is a schematic perspective view of the structure showing the placement of a charging gun and a heating device of FIG. 1;

FIG. 3 is a schematic block diagram of FIG. 1;

FIG. 4 is a schematic perspective view showing the structure of the charging gun of FIG. 1;

FIG. 5 is a schematic perspective view showing a structure of FIG. from another angle;

FIG. 6 is a schematic exploded view of a charging gun body and a heating device of FIG. 4;

FIG. 7 is an exploded view of the heating device of FIG. 4;

FIG. 8 is a schematic front view of a partial cross-section of the charging gun of FIG. 4;

FIG. 9 is a schematic perspective view showing a structure of a charging station system according to a second embodiment of the present disclosure;

FIG. 10 is a schematic perspective view showing a structure of FIG. 9 from another angle;

FIG. 11 is a schematic front view of FIG. 9; and

FIG. 12 is a schematic perspective view showing a structure of a charging station system according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

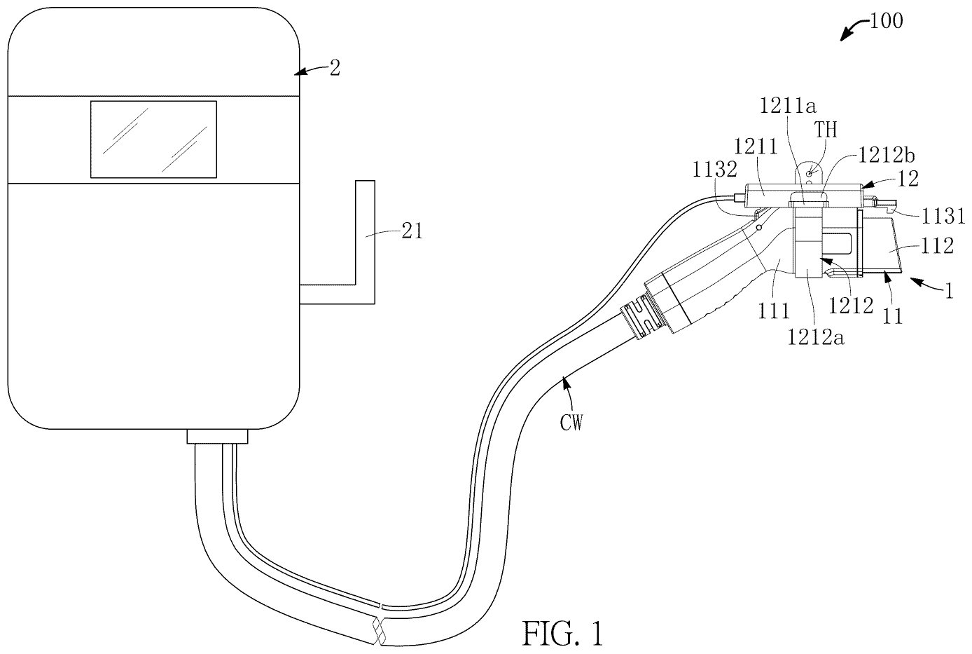

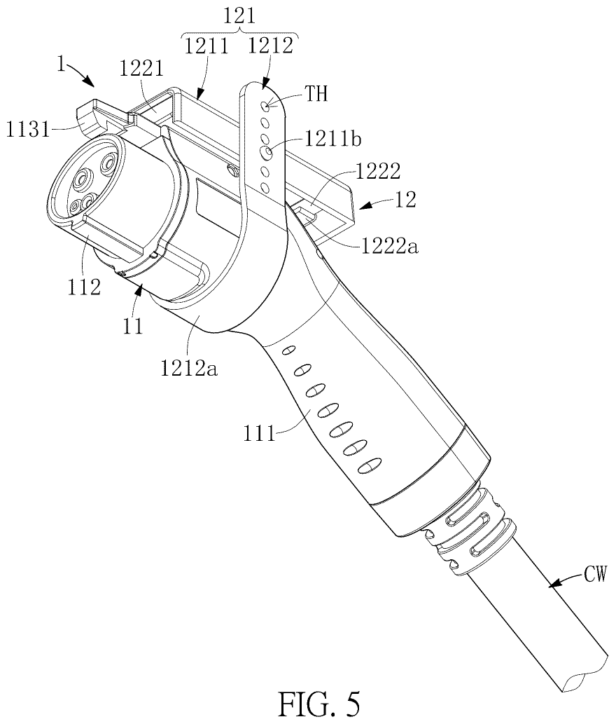

Referring to FIG. 1 to FIG. 8, a first embodiment of the present disclosure provides a charging station system 100 that is configured to heat a charging gun 1 to prevent the charging gun 1 from freezing and being unable to be inserted into a charging socket (not shown in the drawings) of an electric vehicle (not shown in the drawings).

It should be noted that, in order to facilitate understanding of the present embodiment, the drawings of the present embodiment only show a partial structure of the charging station system 100 so as to clearly show structure and connection relationship of each of the components of the charging station system 100, but the present disclosure is not limited to what is shown in the drawings. The structure and the connection relationship of each of the components of the charging station system 100 in the present embodiment will be introduced below.

As shown in FIG. 1 to FIG. 3, the charging station system 100 includes a charging gun 1 and a charging station 2 that is connected to the charging gun 1. The charging gun 1 is connected to the charging station 2 through the connecting wire CW. The charging gun 1 is configured to be inserted into the charging socket of the electric vehicle to charge the electric vehicle.

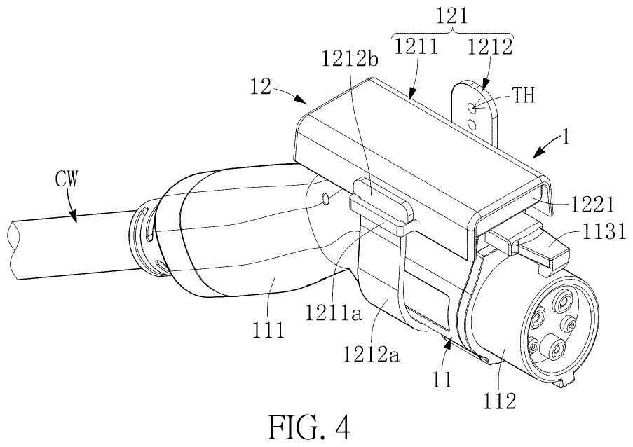

As shown in FIG. 4 to FIG. 6, the charging gun 1 includes a charging gun body 11 and a heating device 12 that is detachably installed on the charging gun body 11. The charging gun body 11 includes a charging gun main body 111, a nozzle 112 that is connected to the charging gun main body 111, and a positioning structure 113 that is pivotally connected to the charging gun main body 111. The nozzle 112 is connected to a front end of the charging gun main body 111, and the nozzle 112 includes a plurality of connecting terminals. When the charging gun main body 111 is connected to the electric vehicle, the nozzle 112 is inserted into the charging socket of the electric vehicle. This is a technique well known to those skilled in the art, and the present disclosure is not described herein for sake of brevity.

When the charging gun main body 111 is connected to the electric vehicle, the positioning structure 113 is fixed to the charging socket of the electric vehicle, so that the charging gun main body 1111 is fixed and positioned at the charging socket of the electric vehicle. In the present embodiment, the positioning structure 113 has a hook 1131 and a pressing portion 1132 located on opposite sides. The hook 1131 is located above the nozzle 112, and the pressing portion 1132 is configured to be pressed to enable the hook 1131 to move between a locking position and an unlocking position. When the positioning structure 113 is fixed to the charging socket of the electric vehicle, the hook 1131 is at the locking position and is engaged with the charging socket to fix the charging gun main body 111.

The pressing portion 1132 is configured to unlock the hook 1131. Specifically speaking, since the pressing portion 1132 and the hook 1131 are located on opposite sides of the positioning structure 113, and a middle position of the positioning structure 113 is pivotally connected to the charging gun main body 111, the pressing portion 1132 is pressed to unlock the hook 1131. Specifically, when the pressing portion 1132 is pressed and moves downward, the hook 1131 correspondingly moves upward to the unlocking position, thereby allowing the hook 1131 to disengage from the charging socket, so that the charging gun main body 111 can be detached from the charging socket of the electric vehicle.

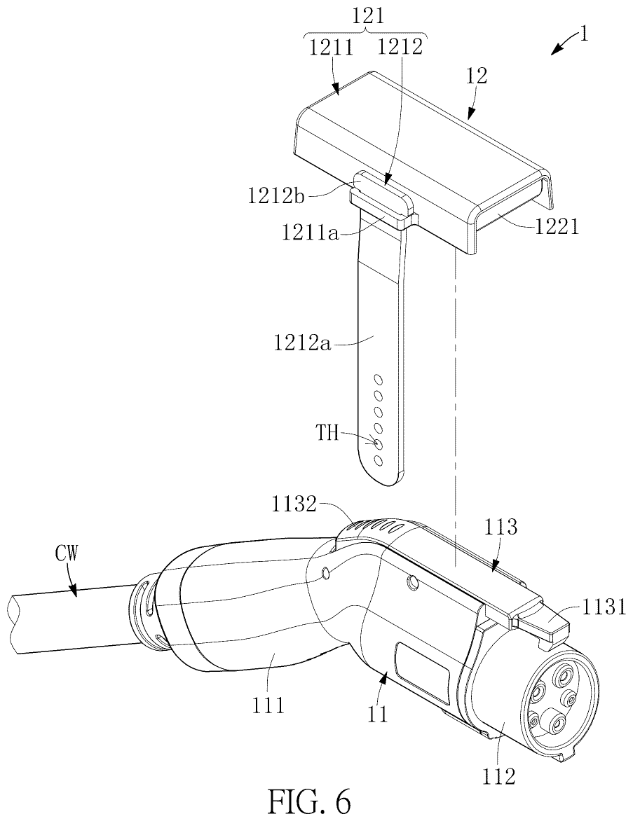

As shown in FIG. 6 to FIG. 8, the heating device 12 is capable of generating heat when an environmental temperature is too low, thereby heating the charging gun body 11 and preventing the charging gun body 11 from freezing, which would otherwise make it impossible for the charging gun body 11 to be inserted into the charging socket of the electric vehicle.

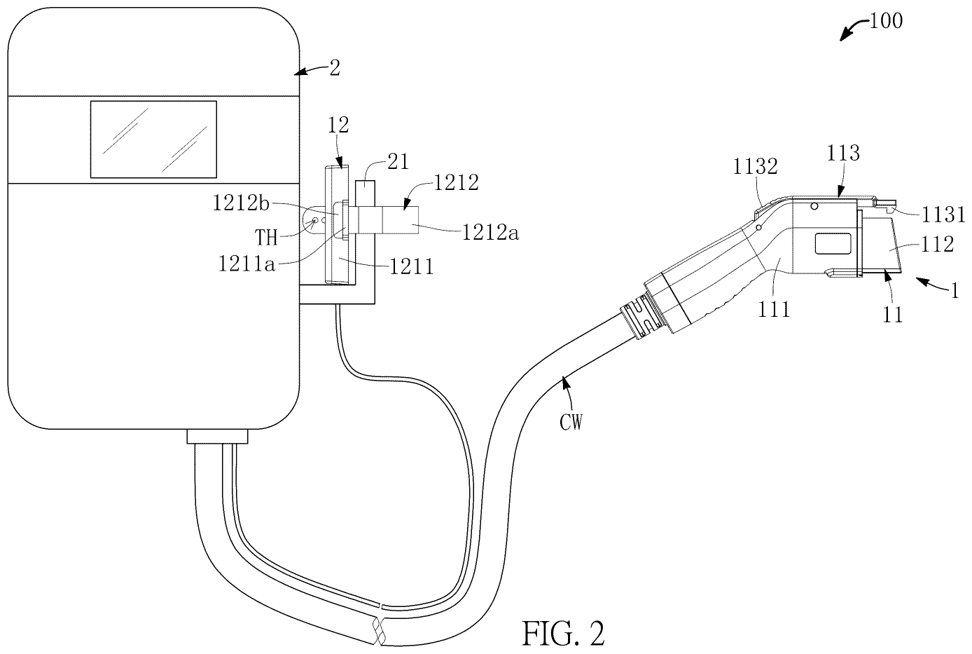

More specifically, when the environmental temperature is too low (e.g., temperature falls below freezing) and causes the charging gun body 11 to freeze, thereby rendering the pressing portion 1132 of the positioning structure 113 inoperable, the heating device 12 can be installed on the charging gun body 11 to heat and thaw the charging gun body 11. When the environmental temperature is not too low, the heating device 12 can be stored in a storage device 21 of the charging station 2 (as shown in FIG. 2), but the present disclosure is not limited thereto. For example, the heating device 12 is configured to be permanently installed on the charging gun body 11, or can be adjusted and changed according to actual design requirements.

The heating device 12 includes a fixing device 121 and a heating module 122 that is disposed in the fixing device 121. The fixing device 121 is detachably installed on the charging gun body 11. More specifically, the fixing device 121 is configured to mount the heating module 122 onto the charging gun body 11, thereby enabling the heating module 122 to heat the charging gun body 11.

In the present embodiment, the fixing device 121 includes a cover body 1211 and a fixing assembly 1212 that is connected to the cover body 1211. The cover body 1211 is covered on the heating module 122. Specifically speaking, the cover body 1211 is covered on the heating module 122 in a direction close to the charging gun body 11, so that the heating module 122 is against the charging gun body 11, and the heat is generated by the heating module 122 to be rapidly transferred to the charging gun body 11, but the present disclosure is not limited thereto. For example, the cover body 1211 can also be a box body or can be adjusted according to actual design requirements.

The fixing assembly 1212 has two ends located on opposite sides, and the two ends of the fixing assembly 1212 are wrapped around the charging gun body 11 along an outer edge of the charging gun body 11 and are respectively fixed to two sides of the cover body 1211. Accordingly, the fixing device 121 cooperates with the fixing assembly 1212 through the cover body 1211, so that the heating module 122 is against the positioning structure 113 of the charging gun body 11.

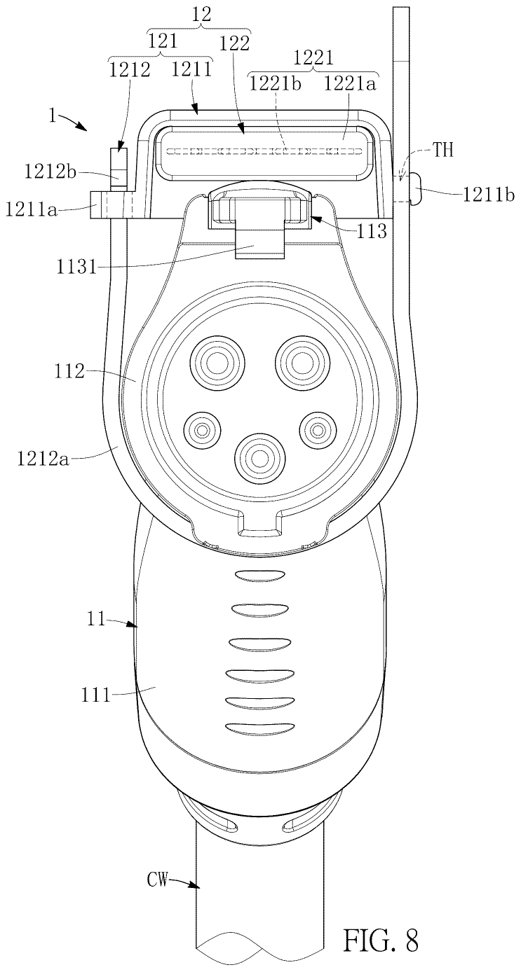

As shown in FIG. 6 to FIG. 8, in the present embodiment, the cover body 1211 has a first side and a second side located on opposite sides. A limit ring 1211a is formed on the first side (as shown in FIG. 6), and a positioning pillar 1211b is formed on the second side (as shown in FIG. 8). The fixing assembly 1212 includes a belt body 1212a and a wide body 1212b that is connected to the belt body 1212a. The belt body 1212a has a first end and a second end located on opposite ends. A plurality of fixing holes TH are formed on the first end, and the wide body 1212b is formed on the second end of the belt body 1212a. A width of the wide body 1212b is greater than a width of the belt body 1212a.

The fixing assembly 1212 and the cover body 1211 of the present embodiment are assembled as follows: the first end of the belt body 1212a passes through the limit ring 1211a, so that the wide body 1212b abuts against the limit ring 1211a, and the belt body 1212a is wound around the charging gun body 11 along the outer edge of the charging gun body 11 so that the positioning pillar 1211b passes through one of the fixing holes TH, so as to complete the installation of the fixing device 121 on the charging gun body 11. It should be noted that, the fixing device 121 is configured to adjust a tightness of the charging gun body 11 by using the fixing holes TH of the belt body 1212a.

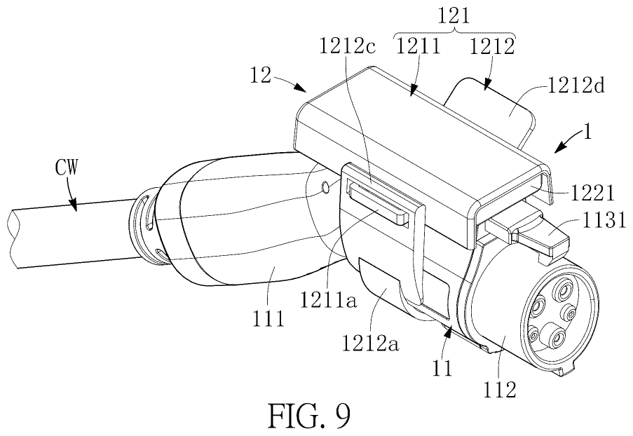

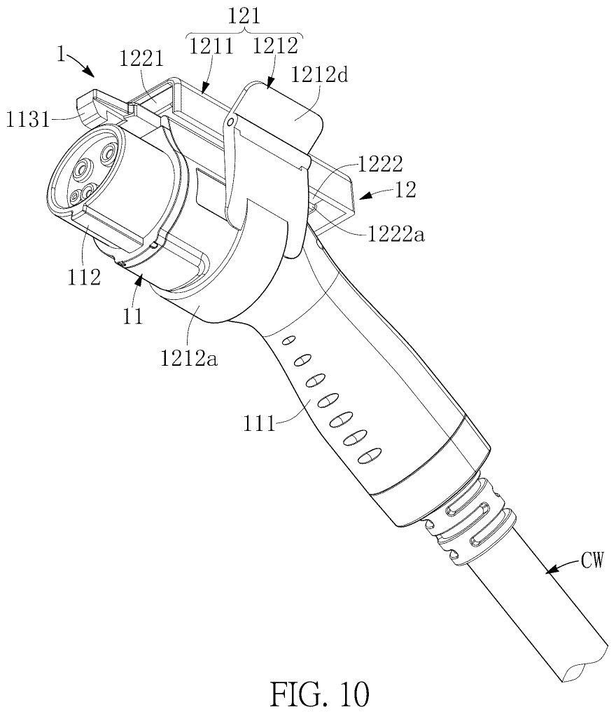

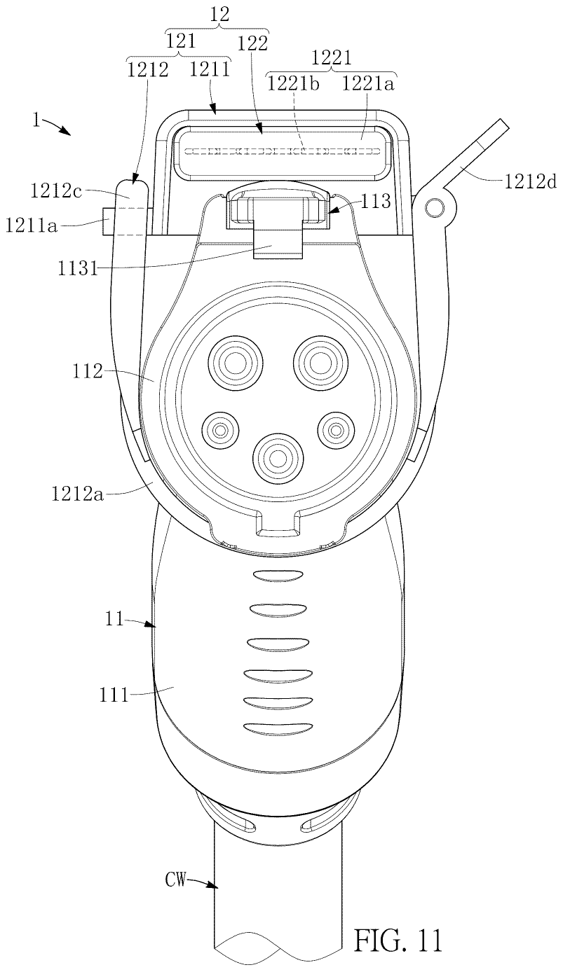

As shown in FIG. 9 to FIG. 11, a second embodiment of the fixing device 121 of the present disclosure, which is similar to the above-mentioned first embodiment, is provided. For the sake of brevity, descriptions of the same components in the first and second embodiments of the present disclosure will be omitted herein, and the following description only discloses different features between the first and second embodiments.

In the present embodiment, a clamping element 1212d is disposed on the first end of the belt body 1212a, and a fixing element 1212c is disposed on the second end of the belt body 1212a. The fixing assembly 1212 and the cover body 1211 are assembled as follows: the fixing element 1212c is fixed to the limit ring 1212a of the cover body 1211, the belt body 1212a is wrapped around the charging gun body 11 along the outer edge of the charging gun body 11, and the clamping element 1212d is fixed on the second side of the cover body 1211, so that the heating module 122 is installed on the charging gun body 11, but the present disclosure is not limited thereto. For example, the fixing assembly 1212 can also be configured as a hook-and-loop fastener, or can be adjusted and changed according to actual design requirements.

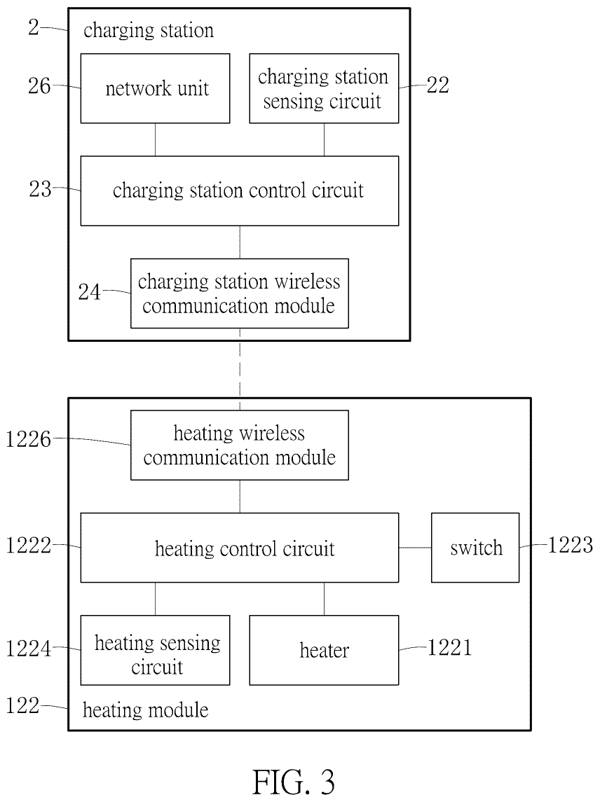

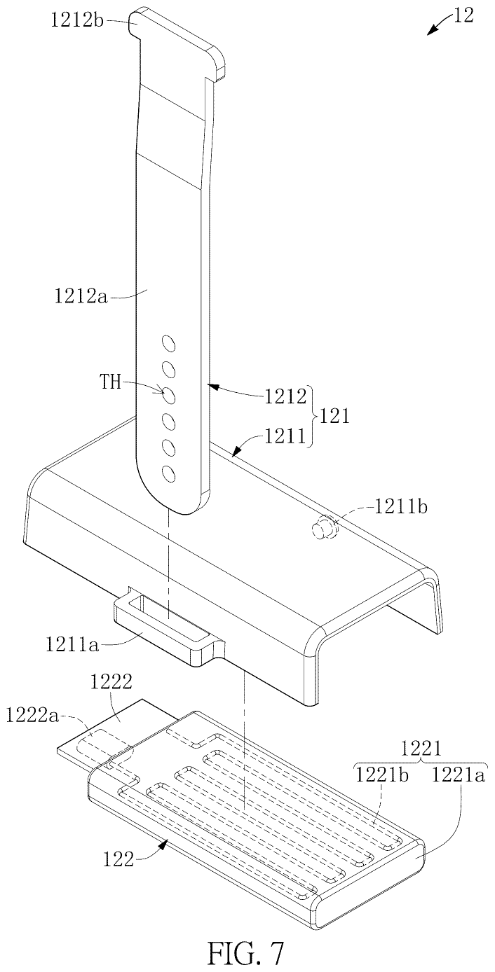

Further referring to FIG. 3, FIG. 6, and FIG. 7, the heating module 122 includes a heater 1221 and a heating control circuit 1222 that is electrically coupled to the heater 1221. The heater 1221 is disposed on one side of the fixing device 121 adjacent to the positioning structure 13 of the charging gun body 11. The heating control circuit 1222 is configured to start the heater 1221 to generate the heat energy, so that the heater 1221 heats the positioning structure 113 of the charging gun body 11 through the heat energy.

More specifically, in the present embodiment, the heater 1221 includes an accommodating housing 1221a and a heating tube 1221b that is disposed in the accommodating housing 1221a. The heating tube 1221b is electrically coupled to the heating control circuit 1222. The heating tube 1221b is controlled by the heating control circuit 1222 to generate the heat energy. In other words, the heating control circuit 1222 is configured to start the heating tube 1221b so that the heating tube 1221b heats the positioning structure 113 of the charging gun body 11.

It should be noted that, the heater is a positive temperature coefficient (PTC) heater, a heat-conductive positive temperature coefficient heater, an infrared ceramic heater, or a high thermal conductivity composite material heater.

Furthermore, the heating module 122 further includes a switch 1223 that is electrically coupled to the heating control circuit 122. The switch 1223 is configured to control the heating control circuit 1222 to start or stop. Specifically speaking, when the switch 1223 is pressed, the heating control circuit 1222 is started to control the heater 1221 to generate the heat energy. When the switch 1223 is not pressed, the heating control circuit 1222 is configured to stop operating. It should be noted that, the switch 1223 is a push-button switch or a proximity switch, but the present disclosure is not limited thereto.

As shown in FIG. 3, FIG. 6, and FIG. 7, the heating module 122 further includes a heating sensing circuit 1224 that is connected to the heating control circuit 1222. The heating sensing circuit 1224 is configured to sense temperature and humidity of a surrounding environment of the heating module 122 to generate a heating temperature signal and a heating humidity signal. The heating sensing circuit 1224 transmits the heating temperature signal and the heating humidity signal to the heating control circuit 1222.

The heating control circuit 1222 has a first heating temperature threshold and a heating humidity threshold. After the heating control circuit 1222 obtains the heating temperature signal and the heating humidity signal, the heating control circuit 1222 is configured to compare a difference between the heating temperature signal and the first heating temperature threshold, or compare the difference between the humidity signal and the heating humidity threshold, and determine whether to start the heater 1221 to generate the heat energy.

Specifically speaking, when the heating temperature signal is less than a first heating temperature threshold or the heating humidity signal is greater than a heating humidity threshold, the heating control circuit 1222 is configured to start the heater 1221 to generate the heat energy. It should be noted that, when the heating device 12 is installed on the charging gun body 11 through the fixing device 121, the heating module 122 is configured to detect the temperature and humidity of the surrounding environment around the charging gun body 11 through the heating sensing circuit 1224, and automatically control the heater 1221 to generate heat energy according to the temperature and humidity.

In addition, the heating control circuit 1222 further has a second heating temperature threshold. The second heating temperature threshold is greater than the first heating temperature threshold. When the heating control circuit 1222 detects that the heating temperature signal is greater than the second heating temperature threshold, the heating control circuit 1222 is configured to stop the heater 1221. It should be noted that, in the present embodiment, the heating control circuit 1222 regulates an operation of the heater 1221 by utilizing the temperature signal in conjunction with the first heating temperature threshold and second heating temperature threshold, thereby achieving constant temperature control of the heater 1221. This mechanism ensures temperature regulation of the charging gun body 11 to prevent freezing.

As shown in FIG. 3, FIG. 6, and FIG. 7, the heating control circuit 1222 has a power connector 1222a. The heating control circuit 1222 is electrically coupled to the charging station 2 (as shown in FIG. 1) through the power connector 1222a to receive electric power provided by the charging station 2.

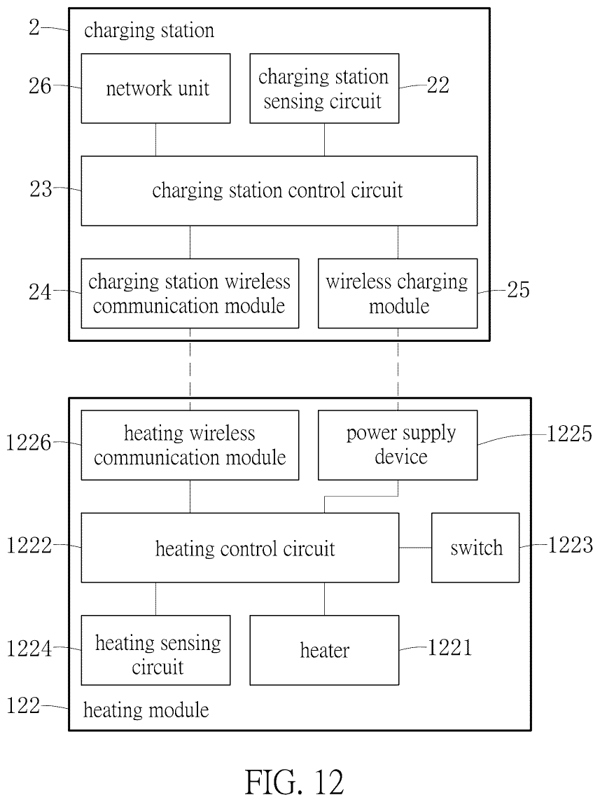

As shown in FIG. 6, FIG. 7, and FIG. 12, the heating module 122 further includes a power supply device 1225. The power supply device 1225 is configured to provide electric power to the heating control circuit 1222, so that the heating control circuit 1222 is configured to start the heater 1221 to generate the heat energy. It should be noted that, the power supply device 1225 is configured to provide the electric power to the heating control circuit 1222 in a wireless transmission manner.

For example, the power supply device 1225 has a transmitting coil (not shown in the drawings), and the heating control circuit 1222 has a corresponding receiving coil (not shown in the drawings). The power supply device 1225 transmits the electric power to the receiving coil through the transmitting coil, and the heating control circuit 1222 receives the electric power transmitted by the power supply device 1225 through the receiving coil, but the present disclosure is not limited thereto. For example, the heating control circuit 1222 is electrically coupled to the power supply device 1225 through the power connector 1222a to receive the electric power from the power supply device 1225.

As shown in FIG. 1 to FIG. 3, the charging station 2 includes a charging station sensing circuit 22, a charging station control circuit 23 that is electrically coupled to the charging station sensing circuit 22, a charging station wireless communication module 24 that is electrically coupled to the charging station control circuit 23, a wireless charging module 25 that is electrically coupled to the charging station control circuit 23, and a network unit 26 that is electrically coupled to the charging station control circuit 23.

The charging station sensing circuit 22 detects the temperature and the humidity around the charging station 2 to generate a charging station temperature signal and a charging station humidity signal. The charging station control circuit 23 receives the charging station temperature signal and the charging station humidity signal, and the charging station control circuit 23 has a charging station temperature threshold and a charging station humidity threshold. When the charging station temperature signal is less than the charging station temperature threshold or the charging station humidity signal is greater than the charging station humidity threshold, the charging station control circuit 23 is configured to generate a charging station control signal to control the heating control circuit 1222, thereby starting the heater 1221 to generate the heat energy.

The charging station wireless communication module 24 transmits the charging station control signal to the heating control circuit 1222 through a heating wireless communication module 1226 of the heating module 122 to control the heating control circuit to start the heater 1221 to generate the heat energy. In other words, the charging station wireless communication module 24 transmits the charging station control signal to the heating wireless communication module 1226. The heating wireless communication module 1226 then transmits the charging station control signal to the heating control circuit 1222. The heating control circuit 1222 is configured to start the heater 1221 to generate the heat energy according to the charging station control signal.

As set forth above, the charging station system 100 of the present disclosure is configured to detect environmental temperature and humidity either through the charging station sensing circuit 22 or the heating sensing circuit 1224, thereby controlling the heating control circuit 1222 to start the heater 1221 for generating heat energy. This configuration enhances design flexibility and diversity.

In addition, the heating control circuit 1222 is configured to determine whether to start the heater 1221 to generate the heat energy according to the charging station temperature signal and the charging station humidity signal generated by the charging station sensing circuit 22, and the heating temperature signal and the heating humidity signal generated by the heating sensing circuit 1224.

More specifically, in the present embodiment, the heating control circuit 1222 is configured to receive the charging station temperature signal and the charging station humidity signal through the charging station wireless communication module 24 and the heating wireless communication module 1226, and the heating control circuit 1222 receives the heating temperature signal and the heating humidity signal of the heating sensing circuit 1224. The heating control circuit 1222 in the present embodiment further has the charging station temperature threshold and the charging station humidity threshold. When the heating temperature signal is less than the first heating temperature threshold and the charging station temperature signal is less than the charging station temperature threshold, the heating control circuit 1222 is configured to start the heater 1221 to generate the heat energy. Alternatively, when the heating humidity signal is greater than the heating humidity threshold, and the charging station humidity signal is greater than the charging station humidity threshold, the heating control circuit 1222 is configured to start the heater 1221 to generate the heat energy. Accordingly, the heating control circuit 1222 is configured to perform dual sensing verification to ensure that the charging gun body 11 is heated when the environmental temperature is too low or the environmental humidity is too high.

Furthermore, as shown in FIG. 1 to FIG. 3, the wireless charging module 25 is configured to charge the power supply device 1225 of the heating module 122. In the present embodiment, the wireless charging module 25 is configured to be disposed adjacent to the storage device 21. When the charging gun 1 is not in use and the heating device 12 is placed in the storage device 21, the wireless charging module 25 is configured to charge the power supply device 1225 in the storage device 21. Specifically speaking, when the power supply device 1225 is close to the wireless charging module 25, the wireless charging module 25 is configured to charge the power supply device 1225 in a wireless transmission manner.

The network unit 26 is linked to the Internet. The charging station control circuit 23 downloads weather information (e.g., temperature, humidity, rain, and snow) from a meteorological website on the Internet through the network unit 26. The charging station control circuit 23 is configured to generate a power control signal according to the weather information. The charging station wireless communication module 24 is configured to transmit the power control signal to the heating control circuit 1222 through the heating wireless communication module 1226 of the heating module 122 to control power of the heater 1221.

For example, when the temperature downloaded by the charging station control circuit 23 (i.e., the weather information) is minus 10 degrees Celsius, the charging station control circuit 23 generates the power control signal according to the temperature of minus 10 degrees Celsius. The power control signal is then transmitted to the heating control circuit 1222 through the charging station wireless communication module 24 and the heating wireless communication module 1226, so as to control the power of the heater 1221 to be 1000 watts; when the temperature downloaded by the charging station control circuit 23 is minus 5 degrees Celsius, the charging station control circuit 23 is configured to generate the power control signal according to the temperature of minus 5 degrees Celsius, so as to control the power of the heater 1221 to be 500 watts, but the present disclosure is not limited thereto.

Furthermore, the charging station control circuit 23 is configured to generate freeze prediction information according to the weather information, and the charging station control circuit 23 is configured to transmit the freeze prediction information to a corresponding user through the network unit 26. For example, the charging station control circuit 23 obtains weather information for the coming days from the meteorological website. When the meteorological network indicates snowy weather for the following day, the charging station control circuit 23 identifies the upcoming snow conditions from the downloaded meteorological information and generates the freeze prediction information, and the charging station control circuit 23 transmits the freeze prediction information to the corresponding user through the network unit 26 to remind the user to pay attention to the status of the charging gun body 11 tomorrow.

### Beneficial Effects of the Embodiment

In conclusion, in the charging station system, the charging gun, and the heating device provided by the present disclosure, by virtue of “a heating device detachably installed on the charging gun body,” and “the heating control circuit is configured to start the heater, so that the heater is configured to heat the positioning structure of the charging gun body,” thereby increasing convenience of use.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A charging station system, comprising:
a charging station; and
a charging gun connected to the charging station through a connecting wire, wherein the charging gun includes:
a charging gun body; and
a heating device detachably installed on the charging gun body, wherein the heating device includes:
a fixing device; and
a heating module disposed in the fixing device, wherein the heating module includes:
a heater disposed on one side of the fixing device adjacent to a positioning structure of the charging gun body; and
a heating control circuit electrically coupled to the heater, wherein the heating control circuit is configured to start the heater, so that the heater is configured to heat the positioning structure of the charging gun body.

2. The charging station system according to claim 1, wherein the heating module further includes a switch that is electrically coupled to the heating control circuit, and wherein the switch is configured to control the heating control circuit to start or stop.

3. The charging station system according to claim 2, wherein the switch is a push-button switch or a proximity switch.

4. The charging station system according to claim 1, wherein the fixing device includes:
a cover body covered on the heating module; and
a fixing assembly having two ends located on opposite sides, and wherein the two ends of the fixing assembly are wrapped around the charging gun body along an outer edge of the charging gun body and are respectively fixed to two sides of the cover body.

5. The charging station system according to claim 4, wherein the cover body has a first side and a second side located on opposite sides, a limit ring is formed on the first side, and a positioning pillar is formed on the second side, wherein the fixing assembly includes a belt body and a wide body that is connected to the belt body, the belt body has a first end and a second end located on opposite ends, a plurality of fixing holes are formed on the first end, and the wide body is formed on the second end of the belt body; and wherein the first end of the belt body passes through the limit ring, so that the wide body abuts against the limit ring, and the belt body is wound around the charging gun body along the outer edge of the charging gun body so that the positioning pillar passes through one of the fixing holes.

6. The charging station system according to claim 4, wherein the cover body has a first side and a second side located on opposite sides, a limit ring is formed on the first side, wherein the fixing assembly includes a belt body, the belt body has a first end and a second end located on opposite ends, a clamping element is disposed on the first end, and a fixing element is disposed on the second end, and wherein the fixing element is fixed to the limit ring, the belt body is wrapped around the charging gun body along the outer edge of the charging gun body, and the clamping element is fixed on the second side of the cover body.

7. The charging station system according to claim 1, wherein the heating module further includes a heating sensing circuit that is connected to the heating control circuit, the heating sensing circuit is configured to sense temperature and humidity of a surrounding environment of the heating module to generate a heating temperature signal and a heating humidity signal, and the heating sensing circuit transmits the heating temperature signal and the heating humidity signal to the heating control circuit; and wherein, when the heating control circuit detects that the heating temperature signal is less than a first heating temperature threshold or the heating humidity signal is greater than a heating humidity threshold, the heating control circuit is configured to start the heater.

8. The charging station system according to claim 7, wherein, when the heating control circuit detects that the heating temperature signal is greater than a second heating temperature threshold, the heating control circuit is configured to stop the heater; and wherein the second heating temperature threshold is greater than the first heating temperature threshold.

9. The charging station system according to claim 1, wherein the heater includes:
an accommodating housing; and
a heating tube disposed in the accommodating housing, the heating tube is electrically coupled to the heating control circuit, and the heating control circuit is configured to start the heating tube, so that the heating tube is configured to heat the positioning structure of the charging gun body.

10. The charging station system according to claim 1, wherein the heater is a positive temperature coefficient (PTC) heater, a heat-conductive positive temperature coefficient heater, an infrared ceramic heater, or a high thermal conductivity composite material heater.

11. The charging station system according to claim 1, wherein the heating module further includes a power supply device, and wherein the power supply device is configured to provide electric power to the heating control circuit, so that the heating control circuit is configured to start the heater.

12. The charging station system according to claim 11, wherein the heating control circuit has a power connector, and wherein the heating control circuit is electrically coupled to the power supply device through the power connector to receive the electric power from the power supply device.

13. The charging station system according to claim 11, wherein the power supply device is configured to provide the electric power to the heating control circuit in a wireless transmission manner.

14. The charging station system according to claim 11, wherein the charging station includes a wireless charging module, and wherein, when the power supply device is close to the wireless charging module, the wireless charging module is configured to charge the power supply device by wireless transmission.

15. The charging station system according to claim 1, wherein the charging station includes:
a charging station sensing circuit detecting the temperature and the humidity around the charging station to generate a charging station temperature signal and a charging station humidity signal;
a charging station control circuit electrically coupled to the charging station sensing circuit, and the charging station control circuit receiving the charging station temperature signal and the charging station humidity signal;
and wherein, when the charging station temperature signal is less than a charging station temperature threshold or the charging station humidity signal is greater than a charging station humidity threshold, the charging station control circuit is configured to generate a charging station control signal; and
a charging station wireless communication module electrically coupled to the charging station control circuit, and wherein the charging station wireless communication module transmits the charging station control signal to the heating control circuit through a heating wireless communication module of the heating module to control the heating control circuit to start the heater.

16. The charging station system according to claim 15, wherein the heating module further includes a heating sensing circuit that is connected to the heating control circuit, the heating sensing circuit is configured to sense temperature and humidity of a surrounding environment of the heating module to generate a heating temperature signal and a heating humidity signal, and the heating sensing circuit transmits the heating temperature signal and the heating humidity signal to the heating control circuit; and wherein, when the heating control circuit detects that the heating temperature signal is less than a first heating temperature threshold and the charging station temperature signal is less than the charging station temperature threshold, the heating control circuit is configured to start the heater, and wherein, when the heating control circuit detects that the heating humidity signal is greater than a heating humidity threshold and the charging station humidity signal is greater than the charging station humidity threshold, the heating control circuit is configured to start the heater.

17. The charging station system according to claim 1, wherein the charging station includes:
a network unit;
a charging station control circuit electrically coupled to the network unit, wherein the charging station control circuit downloads weather information from a meteorological bureau website through the network unit, and wherein the charging station control circuit is configured to generate a power control signal according to the weather information; and
a charging station wireless communication module electrically coupled to the charging station control circuit, wherein the charging station wireless communication module is configured to transmit the power control signal to the heating control circuit through a heating wireless communication module of the heating module to control a power of the heater.

18. The charging station system according to claim 17, wherein the charging station control circuit is configured to generate freeze prediction information according to the weather information, and the charging station control circuit is configured to transmit the freeze prediction information to a corresponding user through the network unit.

19. The charging station system according to claim 17, wherein the charging gun body includes a charging gun main body, a nozzle that is connected to the charging gun main body, and the positioning structure that is pivotally connected to the charging gun main body; and wherein the positioning structure has a hook and a pressing portion located on opposite sides, the hook is located above the nozzle, and the pressing portion is configured to be pressed to enable the hook to move between a locking position and an unlocking position.

20. A charging gun, comprising:
a charging gun body; and
a heating device detachably installed on the charging gun body, wherein the heating device includes:
a fixing device; and
a heating module disposed in the fixing device, wherein the heating module includes:
a heater disposed on one side of the fixing device adjacent to a positioning structure of the charging gun body; and
a heating control circuit electrically coupled to the heater, wherein the heating control circuit is configured to start the heater, so that the heater is configured to heat the positioning structure of the charging gun body.

21. The charging gun according to claim 20, wherein the heating module further includes a switch that is electrically coupled to the heating control circuit, and wherein the switch is configured to control the heating control circuit to start or stop.

22. The charging gun according to claim 21, wherein the switch is a push-button switch or a proximity switch.

23. The charging gun according to claim 20, wherein the fixing device includes:
a cover body covered on the heating module; and
a fixing assembly having two ends located on opposite sides, and wherein the two ends of the fixing assembly are wrapped around the charging gun body along an outer edge of the charging gun body and are respectively fixed to two sides of the cover body.

24. The charging gun according to claim 23, wherein the cover body has a first side and a second side located on opposite sides, a limit ring is formed on the first side, and a positioning pillar is formed on the second side, wherein the fixing assembly includes a belt body and a wide body that is connected to the belt body, the belt body has a first end and a second end located on opposite ends, a plurality of fixing holes are formed on the first end, and the wide body is formed on the second end of the belt body; and wherein the first end of the belt body passes through the limit ring, so that the wide body abuts against the limit ring, and the belt body is wound around the charging gun body along the outer edge of the charging gun body so that the positioning pillar passes through one of the fixing holes.

25. The charging gun according to claim 23, wherein the cover body has a first side and a second side located on opposite sides, a limit ring is formed on the first side, wherein the fixing assembly includes a belt body, the belt body has a first end and a second end located on opposite ends, a clamping element is disposed on the first end, and a fixing element is disposed on the second end, and wherein the fixing element is fixed to the limit ring, the belt body is wrapped around the charging gun body along the outer edge of the charging gun body, and the clamping element is fixed on the second side of the cover body.

26. The charging gun according to claim 20, wherein the heating module further includes a heating sensing circuit that is connected to the heating control circuit, the heating sensing circuit is configured to sense temperature and humidity of a surrounding environment of the heating module to generate a heating temperature signal and a heating humidity signal, and the heating sensing circuit transmits the heating temperature signal and the heating humidity signal to the heating control circuit; and wherein, when the heating control circuit detects that the heating temperature signal is less than a first heating temperature threshold or the heating humidity signal is greater than a heating humidity threshold, the heating control circuit is configured to start the heater.

27. The charging gun according to claim 26, wherein, when the heating control circuit detects that the heating temperature signal is greater than a second heating temperature threshold, the heating control circuit is configured to stop the heater; and wherein the second heating temperature threshold is greater than the first heating temperature threshold.

28. The charging gun according to claim 20, wherein the heater includes:
an accommodating housing; and
a heating tube disposed in the accommodating housing, the heating tube is electrically coupled to the heating control circuit, and the heating control circuit is configured to start the heating tube, so that the heating tube is configured to heat the positioning structure of the charging gun body.

29. The charging gun according to claim 20, wherein the heater is a positive temperature coefficient (PTC) heater, a heat-conductive positive temperature coefficient heater, an infrared ceramic heater, or a high thermal conductivity composite material heater.

30. The charging gun according to claim 20, wherein the heating module further includes a power supply device, and wherein the power supply device is configured to provide electric power to the heating control circuit, so that the heating control circuit is configured to start the heater.

31. The charging gun according to claim 30, wherein the heating control circuit has a power connector, and wherein the heating control circuit is electrically coupled to the power supply device through the power connector to receive the electric power from the power supply device.

32. The charging gun according to claim 30, wherein the power supply device is configured to provide the electric power to the heating control circuit in a wireless transmission manner.

33. The charging gun according to claim 20, wherein the charging gun body includes a charging gun main body, a nozzle that is connected to the charging gun main body, and the positioning structure that is pivotally connected to the charging gun main body; and wherein the positioning structure has a hook and a pressing portion located on opposite sides, the hook is located above the nozzle, and the pressing portion is configured to be pressed to enable the hook to move between a locking position and an unlocking position.

34. A heating device, comprising:
a fixing device; and
a heating module disposed in the fixing device, wherein the heating module includes:
a heater; and
a heating control circuit electrically coupled to the heater, wherein the heating control circuit is configured to start the heater, so that the heater is configured to generate heat energy.

35. The heating device according to claim 34, wherein the heating module further includes a switch that is electrically coupled to the heating control circuit, and wherein the switch is configured to control the heating control circuit to start or stop.

36. The heating device according to claim 35, wherein the switch is a push-button switch or a proximity switch.

37. The heating device according to claim 34, wherein the fixing device includes:
a cover body covered on the heating module; and
a fixing assembly having two ends located on opposite sides, and wherein the two ends of the fixing assembly are respectively fixed on the two sides of the cover body.

38. The heating device according to claim 37, wherein the cover body has a first side and a second side located on opposite sides, a limit ring is formed on the first side, and a positioning pillar is formed on the second side, wherein the fixing assembly includes a belt body and a wide body that is connected to the belt body, the belt body has a first end and a second end located on opposite ends, a plurality of fixing holes are formed on the first end, and the wide body is formed on the second end of the belt body; and wherein the first end of the belt body passes through the limit ring, so that the wide body abuts against the limit ring, and the positioning pillar passes through one of the fixing holes so that the first end of the belt body is fixed to the second side of the cover body.

39. The heating device according to claim 37, wherein the cover body has a first side and a second side located on opposite sides, a limit ring is formed on the first side, wherein the fixing assembly includes a belt body, the belt body has a first end and a second end located on opposite ends, a clamping element is disposed on the first end, and a fixing element is disposed on the second end, and wherein the fixing element is fixed to the limit ring, and the clamping element is fixed on the second side of the cover body.

40. The heating device according to claim 34, wherein the heating module further includes a heating sensing circuit that is connected to the heating control circuit, the heating sensing circuit is configured to sense temperature and humidity of a surrounding environment of the heating module to generate a heating temperature signal and a heating humidity signal, and the heating sensing circuit transmits the heating temperature signal and the heating humidity signal to the heating control circuit; and wherein, when the heating control circuit detects that the heating temperature signal is less than a first heating temperature threshold or the heating humidity signal is greater than a heating humidity threshold, the heating control circuit is configured to start the heater.

41. The heating device according to claim 40, wherein, when the heating control circuit detects that the heating temperature signal is greater than a second heating temperature threshold, the heating control circuit is configured to stop the heater; and wherein the second heating temperature threshold is greater than the first heating temperature threshold.

42. The heating device according to claim 34, wherein the heater includes:
an accommodating housing; and
a heating tube disposed in the accommodating housing, the heating tube is electrically coupled to the heating control circuit, and the heating control circuit is configured to start the heating tube, so that the heater is configured to generate the heat energy.

43. The heating device according to claim 34, wherein the heater is a positive temperature coefficient (PTC) heater, a heat-conductive positive temperature coefficient heater, an infrared ceramic heater, or a high thermal conductivity composite material heater.

44. The heating device according to claim 34, wherein the heating module further includes a power supply device, and wherein the power supply device is configured to provide electric power to the heating control circuit, so that the heating control circuit is configured to start the heater.

45. The heating device according to claim 44, wherein the heating control circuit has a power connector, and wherein the heating control circuit is electrically coupled to the power supply device through the power connector to receive the electric power from the power supply device.

46. The heating device according to claim 44, wherein the power supply device i configured to provide the electric power to the heating control circuit in a wireless transmission manner.
